(19) United States
(12) Patent Application Publication
(10) Pub. No.: US 2015/0226079 A1
(43) Pub. Date: Aug. 13, 2015

(54) Hydro-Electrenergy

(71) Applicant: Saharat Nikornpan, Island Park, NY (US)

(72) Inventor: Saharat Nikornpan, Island Park, NY (US)

(21) Appl. No.: 14/176,131

(22) Filed: Feb. 9, 2014

(51) Int. Cl. F01D 13/02; F03B 17/02; F01D 15/10

(52) U.S. Cl. CPC F01D 13/02; F01D 15/10; F03B 17/025; Y10S 415/916; F03B 17/04

(57) ABSTRACT

Hydro-electrenergy is a concept that is capable of turning the world energy sources around to the whole new direction from being mainly reliant on carbon footprint to be completely extricated from it. This idea is an innovation of alternative energy sources. It can create the powerful airflow by manipulating the interactions between air and water in our atmosphere and harness the kinetic energy of that powerful airflow, thus an ample supply of electricity is generated around the clock any where on the planet. The entire gadgets of the apparatus are driven by the gravity and buoyancy. The most powerful and reliable forces in the world.

It had been some time in my younger years that I started to realize there was something that could not be deprived from our lives. That was energy. I grew up in a farm with various kinds of livestock. I have engaged in all farm activities especially, machinery and transportation. So I gained mechanical experiences by helping my father whenever he had to engage in mechanical problems. My father was so keen with machinery. Spending my younger years with him gave me a good head start leading me to this invention. At one time he wanted to set up the water turbine on the near by stream. In order to reduce electric bills. I engaged in fully on the set up and so elated when we first generated a considerate amount of electricity from our own invention. Unfortunately, our invention had its own limited capacity. The water current would dwindle when dry season approached. The gadget would be incapacitated for 4-6 months before it could get back to generate electricity again. So it became the only back up system.

This kind of experience in my life becomes a seed being embedded in the soil ready to break off and grow. It is just a matter of right timing. The more I learn about how do we obtain electricity for our energy the more I disagree, even despise. We are living our lives with no plans for the future, no certainty for our new generations to come. In the future when these resources run out or become so scarce, what are we going to do? No body can answer that question. This means no plans into the future which we all invest our new generations in it.

It has long been known that humans have striven for clean and reliable energy to replace the way we are obtaining our energy. Because some of us may have realized of the peril that we are facing not to mention about pollution being created in the process. But with all time and efforts that they have put in, all methods are unreliable just like the one that my father and I have built. The source of energy must be clean, reliable, economical and command able. So I have come up with the system that meets all these requirements.

Introducing HYDRO-ELECTRENERGY. The apparatus that can generate ample supply of electricity by itself around the clock any where on this planet at no running costs. There are no pros and cons to discuss about in this system. This is why the patent should be granted to protect this idea. It is so prominent and unprecedented amongst those methods that people have tried to circumvent the conventional way. It is the only one system that can harness the kinetic energy of the airflow created by interactions between air and water in our natural surroundings. This kinetic energy can generate electricity perpetually. This system should be renowned for innovation of alternative energy that people have striven to obtain for decades.

With the description of the drawings:

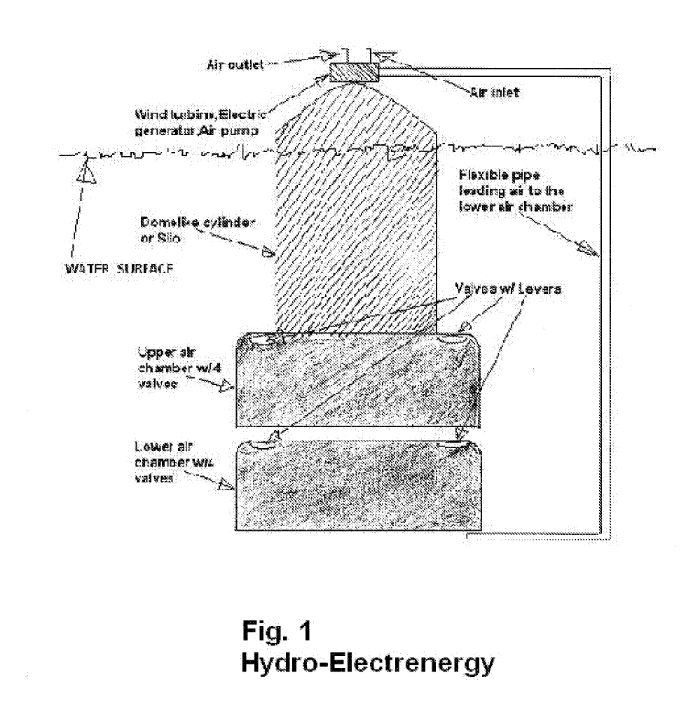

FIG. 1 Hydro-Electrenergy

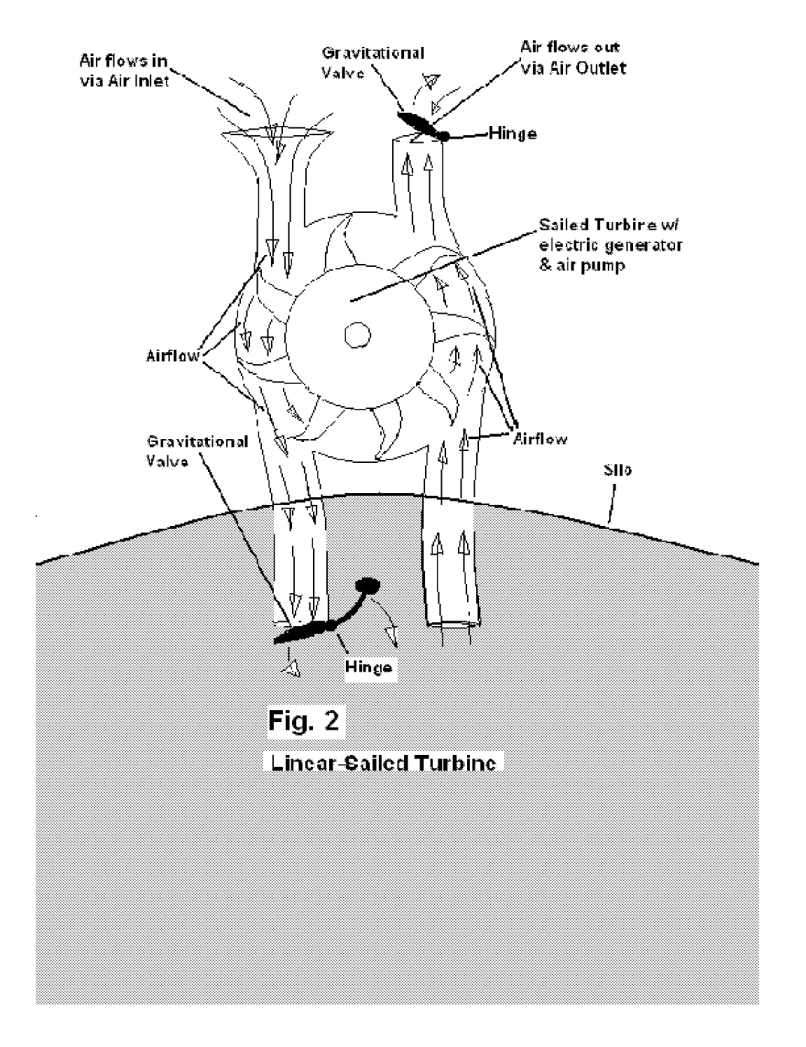

FIG. 2 Linear-Sailed Turbine

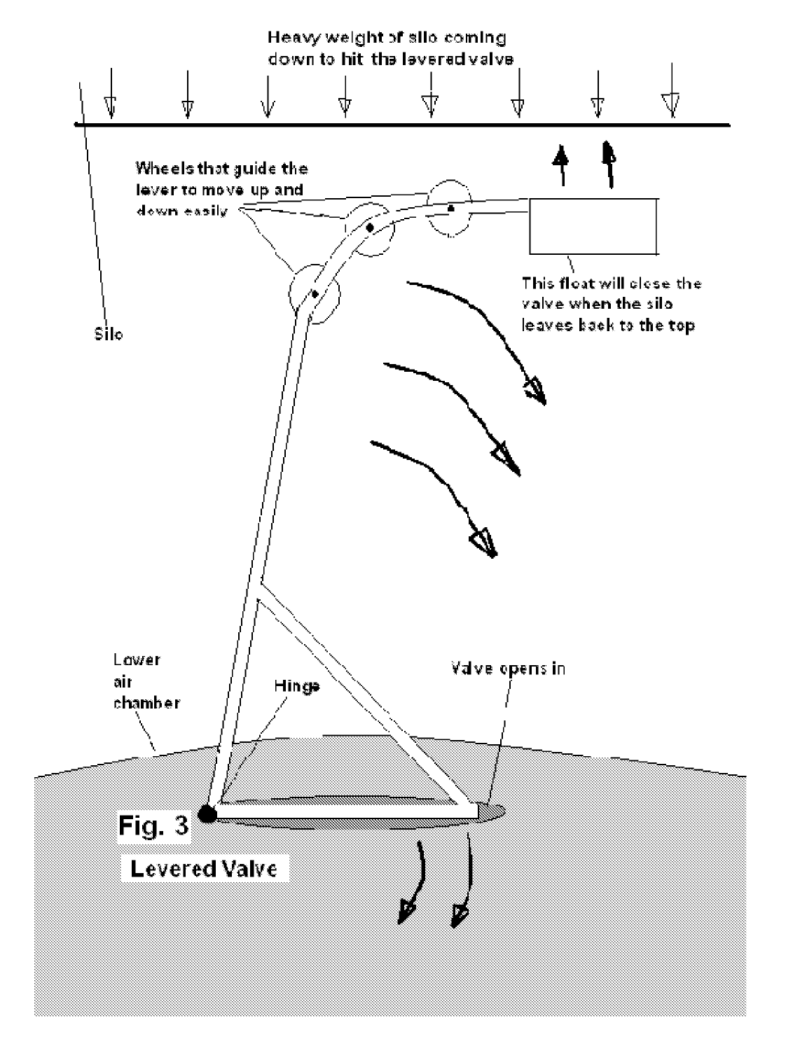

FIG. 3 Levered Valve

1. An apparatus is comprised of:
the silo with a round air chamber (upper air chamber) being affixed at the bottom part of the said silo. The silo is said to move up and down freely on the vertical rails to prevent silo from falling sideways.
Linear-sailed turbine is equipped with electric generator and air pumps. This turbine is said to connect to air inlet and outlet on top of the silo.
a flexible hose from said air pumps conveying the air down to release beneath the said lower air chamber to be trapped there.
lower air chamber is about the same size as upper air chamber. These two air chambers are said to equip with multiple levered valves. These said valves will release the trapped air from the chambers at the appropriate timings. See FIG. 1 Hydro-Electrenergy

2. The silo sinks into the water vertically due to the gravitational forces. As it descends the water inside advances toward the top. The air inside the silo now is pressurized and said to be forced to flow out through the air outlet on its way to kick the sails of linear-sailed turbine. The turbine spins vigorously causing electric generator to generate electricity. At the same spin of turbine, the air pumps are said to convey the air through the flexible hose and release it beneath the lower air chamber to be trapped there. These are ongoing actions all the way until the silo reaches the bottom of the structure. The lower air chamber now is filled with air. At the bottom, said silo hits all levered valves causing them to open all at once. This would allow the trapped air to escape through these opened valves. This trapped air rises up but said to be trapped again in the upper air chamber right above it. The upper air chamber is now filled with air creating buoyant forces to lift this chamber and silo upward the water surface. Now the said silo is filled with water, as it rises upward the water inside recedes in order to maintain the same level as the water outside. The air pressure inside now is dropping lower than the outside air pressure. So the outside air has to find the way to get in with force via air inlet. So the outside air is said to flow in as a forceful airflow passing through the air inlet on its way to kick the sails. The turbine is said to spin vigorously again. Thus, the electricity is generated and air is being conveyed to fill lower air chamber once again. As the silo reaches the top of the rails, the levered valves hit the structure causing all valves to open letting the trapped air out. The buoyancy has gone, the gravity takes over at this point sending the silo to sink back into the water. The same actions are said to start all over again in the new cycle. Now this apparatus is said to be able to generate electricity on both ways, downward and upward.

3. The apparatus is said to be built in metal structure on a cement foundation in a man-made pool 100 feet deep into the ground. The length and width depend on a specific energy need for that said location.

4. As reference to claim 3. The numbers of silo are said to vary in order to have an adequate flow of electricity.

5. As reference to claim 1. A silo is made out of plastic material. This said silo to be assembled from small pieces by plastic welding technology on site as well as the two air chambers.

6. As reference to claim 1. linear-sailed turbine is said to be a disk that rotates vertically with sails (cup-like) being affixed around on its rim. These sails run along inside the enclosed-fitted tube as the disk rotates. Another tube is said to merge in for an access to the sails on the right side of the disk. The sails on this right side are said to face downward to pick up the pressurized airflow from the silo moving upward. This merged tube creates two ends. The bottom end is said to connect into the silo the top end is said to release airflow to the open air space which is called air outlet. On the left side of the disk, there is the same set up as the right but the air will flow in the opposite direction which said to flow down into the silo on its way to kick the same sails which are now facing upward to pick up the kinetic energy of this pressurized airflow from outside. This left side is called air inlet. See FIG. 2 Linear-Sailed Turbine.

7. As reference to claim 1. Linear-sailed turbine is said to have two gravitational valves being installed at air inlet and outlet that said to open and close in alternate timings to direct the airflow to spin the said sailed turbine effectively.

8. As reference to claim 1. The axis of the disk in the said linear-sailed turbine is said to connect to an electric generator. On the other side of the disk is said to connect to two air pumps for conveying the air through the flexible hose to the lower air chamber.

9. As reference to claim 1. The levered valves that situate on top of both said air chambers are very important parts of the system. They are said to determine when each silo goes up and when to come down. They are the “L” shaped look with 75 degrees angle between two arms. The short arm is a part of the valve. The long arm is the leverage to shut or open the valve. Each valve is equipped with the float at the tip of the long arm in order to utilize the buoyant forces. All valves on upper air chamber are equipped with extended arms for the delayed time to shut the valves when the silo sinks down. See FIG. 3 Levered Valve.
